(19) United States
(12) Patent Application Publication
(10) Pub. No.: US 2005/0135993 A1
(43) Pub. Date: Jun. 23, 2005

(54) Manganese oxide based materials as ion intercalation hosts in lithium batteries

(76) Inventors: Jun Xu, Piscataway, NJ (US); Jingsi Yang, Piscataway, NJ (US); Gaurav Jain, Piscataway, NJ (US)

Correspondence Address: Kenneth Watov, Esq.;WATOV & KIPNES, P.C., P.O. Box 247, Princeton Junction, NJ, 08550, US

(21) Appl. No.: 10/744,395

(22) Filed: Dec. 23, 2003

(51) Int. Cl. C01G 45/02; H01M 4/50

(52) U.S. Cl. 423/605; 429/231.1; 429/224

(57) ABSTRACT

The present invention is directed to a process for making an amorphous nanostructured cation-doped manganese oxide material useful as an ion intercalation host for rechargeable batteries, including the steps of preparing a solution containing cation permanganate combined optionally with a cation donor compound, mixing the solution with a reducing agent to yield a hydrogel comprising a manganese oxide compound, cryogenically freezing the hydrogel, drying the frozen gel to yield a cryogel amorphous nanostructured cation-doped manganese oxide, and heat treating the dried cryogel.

### FIELD OF THE INVENTION

The present invention relates generally to manganese oxide based host materials and processes for making the same, and more particularly to cation-doped nanostructured forms of manganese oxides prepared from a novel synthesis process. These materials are useful as ion intercalation host materials for electrodes of rechargeable lithium batteries.

### BACKGROUND OF THE INVENTION

Manganese oxides have been considered an attractive candidate for use as ion intercalation host materials due in part to their lower costs and desirable environmental compatibility. Various forms of crystalline manganese oxides have been investigated including LiMn₂O₄ of the spinel structure. The spinel LiMn₂O₄ suffers from limited intercalation capacity and significant capacity fading upon continual charge/discharge cycling. The various layered structure forms of manganese oxides exhibit higher initial intercalation capacities than the spinel LiMn₂O₄. However, these forms tend to undergo transformation to the thermodynamically stable spinel-like structure upon continual cycling, and exhibit similar performance limitations as those observed with the spinel structure described above, including poor capacity retention characteristics.

Amorphous manganese oxides have recently emerged as a potential new class of cost effective and environmentally friendly lithium intercalation hosts. These amorphous materials exhibit dramatically higher specific capacities than do their crystalline counterparts and provide a promising alternative to crystalline structures for achieving high performance cathodes. Amorphous manganese oxides or nanocrystalline manganese oxides are believed to be able to better resist the tendency for phase transformations typically observed in micro-crystalline materials, and thus in general, exhibit much higher single-phase intercalation capacities. Prior work on amorphous manganese oxides prepared by aqueous synthesis routes show that these materials typically possess very high intercalation capacities, however, attaining a stable cycling performance with such promising materials has been a challenge. A kinetically stabilized structure, that does not undergo rearrangement during electrochemical cycling, is highly desirable in this regard.

Sol-gel synthesis methods are possible routes for synthesis of nanostructured amorphous compounds. Sol-gel routes or aqueous precipitation routes have been extensively employed for synthesis of inorganic materials with micro-sized particles and crystalline structures. Synthesis of various manganese oxides by reduction of alkali permanganates using different reagents has emerged as one such preferred synthesis method. Typically, in these syntheses, an intermediate compound is obtained by reaction of soluble precursors. The resulting intermediate compound is thereafter heated at significantly high temperatures to drive out the reaction solvent, excess reactants and residue that are present to produce the corresponding crystalline structure compound.

In order to obtain nanostructured, largely amorphous products from sol-gel routes, excess reactants, organic residue and the remnant solvent need to be expunged at relatively low temperatures. A nanostructured, amorphous compound can be obtained from the sol-gel routes by employing an effective, low temperature drying strategy. However, materials synthesized by such low temperature routes are inherently meta-stable or process-dependent in nature, and their structure, morphology and electrochemical properties are highly dependent on the choice of reactants and solvent, reaction conditions and the process for drying the products. New synthesis approaches have thus been investigated to produce materials having better performance characteristics.

Various aerogel, ambigel forms of nanostructured manganese oxide-based intercalation compounds have been synthesized. These materials exhibit relatively high surface areas thus possessing high initial intercalation capacities. However, the structures of these materials are generally less tolerable to repeated cycling and experience drastic deterioration in their intercalation capacities upon extended charge/discharge cycling. Amorphous compounds, synthesized in a powder form rather than a monolithic gel-form have been reported, but these compounds also suffer from limited cycling stability. Synthesis methods utilizing organic synthesis media for preparing amorphous manganese oxides have been investigated. The materials synthesized by these routes have exhibited good electrochemical performance, however, the costs associated with a synthesis method involving organic solvents limit the viability of such synthesis routes and the materials produced therefrom.

Accordingly, it would be desirable to develop a process that produces an amorphous nanostructured manganese oxide material useful as an intercalation host for rechargeable lithium batteries. It would also be desirable to develop a process for making such manganese oxide in an aqueous medium at a relatively low temperature. It would be further desirable to develop an amorphous nanostructured manganese oxide material, kinetically-stabilized by cationic doping, with improved performance including enhanced capacity retention as cathode electrodes for rechargeable batteries.

### SUMMARY OF THE INVENTION

The present invention is directed generally to an amorphous nanostructured oxide material and processes for making the same. Preferably, the oxide material is a manganese oxide optionally doped with a cation. The amorphous nanostructured oxide materials of the present invention are synthesized via room temperature sol-gel routes, followed by a freeze-drying processing method. The materials formed and processed therefrom act as stable intercalation hosts for lithium having excellent specific capacities and exhibiting increasingly better capacity retention with increasing dopant concentration. The cation-doped manganese oxide materials of the present invention advantageously remain amorphous throughout the reversible lithium intercalation process that occurs during the charge/discharge cycling.

The process of the present invention produces amorphous nanostructured cation-doped manganese oxides that exhibit a uniform macromolecular distribution, which enhances the electrochemical properties and performance of the materials including improved stability in specific capacity upon charge/discharge cycling. In a preferred embodiment, the process of the present invention involves obtaining amorphous manganese oxide hydrogels which consist of a homogeneous cation-doped amorphous manganese oxide skeleton and an intermingling aqueous phase, which in combination forms a monolith. The process further involves cryogenically freezing the monolithic hydrogel in a suitable cryogenic liquid such as, for example, liquid nitrogen followed by vacuum drying to obtain a cryogel form of nanostructued amorphous manganese oxide. The process of cryogenically freezing and thereafter vacuum drying the gel is collectively referred herein as “freeze-drying”. Optionally, the freeze-dried cryogel can be further heat treated at an elevated temperature to further enhance the uniformity in the concentration of the doped cation in the material. Preferably, the doped cation is selected from lithium, sodium, copper and the like.

In one aspect of the present invention, there is provided an amorphous nanostructured cation-doped manganese oxide material useful as an ion intercalation host for rechargeable batteries, comprising a cryogel derived from a freeze dried hydrogel, wherein the hydrogel is formed from a sol-gel reaction.

In another aspect of the present invention, there is provided a process for making an amorphous nanostructured oxide material useful as an ion intercalation host for rechargeable batteries, comprising the steps of:
preparing an oxide in the form of a hydrogel;
cryogenically freezing the hydrogel; and
vacuum drying the frozen gel to yield an amorphous nanostructured oxide cryogel material.

In a particular aspect of the present invention, there is provided a process for making an amorphous nanostructured cation-doped manganese oxide material useful as an ion intercalation host for rechargeable batteries, comprising the steps of:
preparing a solution comprising a cation containing permanganate salt combined optionally with a cation donor compound;
mixing the solution with a reducing agent to yield a hydrogel comprising a manganese oxide material;
cryogenically freezing the hydrogel; and
vacuum drying the frozen gel to yield an amorphous nanostructured cation-doped cryogel manganese oxide material.

In another particular aspect of the present invention, there is provided a process for making an amorphous nanostructured lithium-containing manganese oxide material useful as an ion intercalation host for rechargeable batteries, comprising the steps of:
preparing a solution containing lithium permanganate combined optionally with lithium hydroxide;
mixing the solution with a reducing agent to yield a hydrogel;
freezing the hydrogel in liquid nitrogen;
vacuum drying the frozen gel to yield an amorphous nanostructured lithium-containing cryogel manganese oxide; and optionally, heat treating the dried cryogel.

The present invention is further directed to amorphous nanostructured oxide materials prepared, in one embodiment of the present invention, by the processes of the present invention. Preferably, the oxide materials are selected from cation-doped manganese oxides.

### BRIEF DESCRIPTION OF THE DRAWINGS

Various embodiments of the invention are described in detail below with reference to the drawings, in which like items are identified by the same reference designation, wherein:

FIG. 1 shows the various reaction steps for the synthesis of cryogel, cation-doped amorphous manganese oxide, outlining the sol-gel process followed by the freeze drying process and other optional steps, for one embodiment of the present invention;

FIG. 2 shows both a transmission electron microscope image of a characteristic manganese oxide cryogel sample, and a selected area electron diffraction pattern (insert), indicating that the material is largely amorphous;

FIG. 3 shows the X-ray diffraction patterns of the different sodium-doped amorphous manganese oxide cryogel samples corresponding to the compositions given in Table 1 (see below);

FIG. 4 shows electrochemical cycling performance of the sodium-doped amorphous manganese oxide cryogel samples between 1.5 and 4.0 V at a rate of 1 mA/cm²;

FIG. 5 shows discharge profiles of a sodium-doped amorphous manganese oxide cryogel sample, identified as G3 in Table 1, at different current rates ranging from C/100 (0.06 mA/cm²), C/5 (1 mA/cm²) and 2C (7.25 mA/cm²);

FIG. 6 shows electrochemical cycling performance of the lithium-doped amorphous manganese oxide cryogel samples, synthesized by reacting lithium permanganate with fumaric acid;

FIG. 7 shows X-ray diffraction patterns of the amorphous Li₂MnO₃ and the crystalline Li₂MnO₃ samples, showing good correspondence in the peak positions and a sharp difference in the peak intensities or crystallinity of the two samples; and

FIG. 8 shows the first discharge profiles of the amorphous Li₂MnO₃ and the crystalline Li₂MnO₃ samples at a rate of 0.01 mA/cm², with an insert showing the performance of the two materials upon repeated cycling at 1 mA/cm².

### DETAILED DESCRIPTION OF THE INVENTION

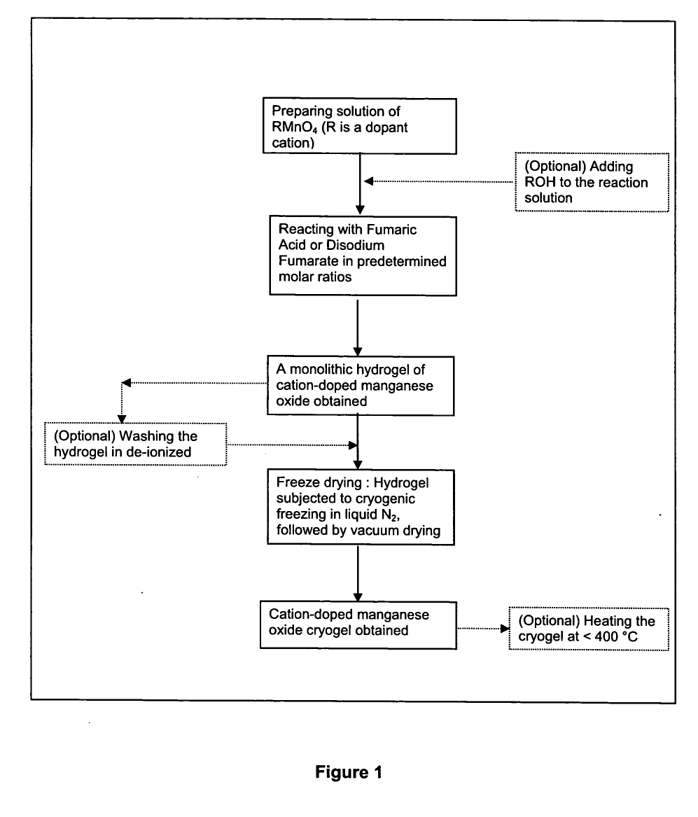

The present invention is directed generally to an amorphous nanostructured cation-doped manganese oxide synthesized as a cryogel, through a combined sol-gel process and freeze drying process as shown in FIG. 1. The sol-gel process of the present invention yields macromolecular inorganic network materials via hydrolysis and condensation reactions that start from molecular precursors. The sol-gel process described herein provides homogeneous distribution of the constituents in the resulting gel and allows precise compositional control to yield compounds exhibiting excellent performance characteristics. The sol-gel process of the present invention also provides good control over the synthesis parameters affecting the oxidation state of manganese in the resultant oxide as well as the morphology of the product. Moreover, the freeze drying method, employed for obtaining a cryogel from the monolithic hydrogel produced from the sol-gel reaction, serves as a highly favorable process for synthesizing high surface area materials with a robust nano-architecture, an amorphous crystal structure and a strictly controlled stoichiometry.

The amorphous nanostructured cation-doped manganese oxides produced from the process of the present invention exhibit excellent cycling stability and performance useful as an ion intercalation host material for cathodes of rechargeable batteries. These nanostructured materials also yield superior high rate performance, namely large intercalation capacities at high current rates, suitable for meeting the increasing demands of present day applications utilizing rechargeable batteries. The amorphous nanostructured cation-doped manganese oxides exhibit a specific capacity of at least 80 mAh/g, preferably from about 80 to 250 mAh/g.

In a preferred embodiment of the present invention, there is provided macromolecular cation doped manganese oxides of the formula RₓMnO_{2+y/2}, wherein R is a doped cation, and x and y are selected from 0 to 2. Suitable doped cations are selected from lithium, sodium, copper and the like.

The amorphous nanostructured manganese oxides of the present invention provide a reversible intercalation host for lithium useful in cathodes of rechargeable batteries. The amorphous materials of the present invention are not adversely affected from irreversible phase changes that are typically associated with crystalline forms of the compounds. The amorphous materials of the present invention yield reversible lithium intercalation capacities, dramatically higher than crystalline materials with similar overall compositions, and also yield excellent cycling performance.

The term “amorphous” is used herein to describe a solid that is not crystalline (i.e., one that has no long-range order in the lattice), and encompasses a range of local atomic arrangements and compositions, wherein x-ray powder diffraction (XRD) may not be capable of distinguishing the difference among them, but may require more detailed structural analysis by other techniques to reveal the differences among different amorphous structures. The term “nanostructured” is used to describe a solid of a morphology with nano-meter scale characteristic lengths, ranging from 1 to 100 nanometers, and preferably about 30 nanometers. The term “cryogel” means a mesoporous solid phase, obtained after removal of the aqueous phase from the hydrogel by sublimation or vacuum drying after cryogenic freezing.

The process of the present invention includes reaction of a cation-doped permanganate salt solution, such as lithium permanganate or sodium permanganate solution, and a reducing agent such as fumaric acid or disodium fumarate to produce a monolithic hydrogel of the corresponding cation-doped manganese oxide. Optionally, a cation donor compound such as lithium hydroxide or sodium hydroxide can be added to raise the concentration of the corresponding cation and increase the ratio of cation to manganese present in the gel. The resulting hydrogel is rapidly frozen in a suitable cryogenic liquid such as, for example, liquid nitrogen and thereafter is vacuum dried to remove water and organics, to yield an amorphous cation-doped manganese oxide cryogel with a high surface area nano-architecture. Examples of suitable dopant cations include lithium, sodium, copper, and the like.

Optionally, the process of the present invention can further include heat treating the freeze-dried cryogel in air at a temperature suitable for inducing the manganese to possess an oxidation state of 4+ and enhance the homogeneity in the concentration of the dopant cations in the material. Preferably, the temperature is less than 400° C., and more preferably from about 250° C. to 400° C. The heat treating process is typically carried for a sufficient period of time which can range from about 12 to 24 hours. The heat treating process provides an air oxidation step through heating to obtain a manganese oxide with manganese in 4+ oxidation state and to obtain a more homogeneous concentration of the doped cation in the material. It is noted that the temperature and time must be selected within the corresponding ranges as to avoid substantial crystallization of the material. To minimize undesirable crystallization, higher concentrations of doped cations have been found helpful in retarding the kinetics of rearrangement and crystallization that can occur during the heat treating process, thus preserving the largely amorphous structure of the cryogel.

The process of the present invention is used to synthesize short-range-order or amorphous cation-doped manganese oxide cryogels, while facilitating precise cationic doping control. Amorphous manganese oxide compounds exhibit extremely promising properties, primarily owing to their short-range-order structure, which prevents global phase transformations and detrimental structural changes. Suitable cationic doping into the amorphous manganese oxide structure, achieved using the method of this invention, helps attain better kinetic stabilization of the structure, offering superior long-term cycling stability.

The freeze drying process plays a critical role in preserving the amorphous structure and the nanostructured architecture inherent in the hydrogel. The sublimation process in freeze drying further functions to eliminate or substantially reduce the surface tension or capillary forces generated by the liquid phase from crushing the nano-architecture of the hydrogel, which would otherwise have occurred during the direct evaporation of the liquid phase through heating. The freeze drying process also prevents the crystallization effects and reduced porosity normally associated with high temperature drying processes. Further, the process of the present invention facilitates molecular mixing of the reactants and enables precise control of the final composition of the doped cation (e.g., lithium, sodium and copper). It is further observed that cycling performance is enhanced through increases in the cation to manganese ratio. Applicants theorize that increased concentrations of cationic dopants provide an enhanced kinetic stabilization effect in the material.

One of the main advantages of utilizing the synthesis process described above is ease of doping. Other elements can be readily introduced as dopants into the manganese oxide in a range of compositions by utilizing a suitable precursor material for synthesis. For example, copper containing amorphous nanostructured manganese oxides can be synthesized by adding a solution of a copper donor compound such as copper (II) sulfate to a lithium permanganate precursor solution in appropriate desired ratios. The rest of the synthesis process steps remain the same as described above. The copper content of the resulting material can be determined by ICP/atomic absorption analysis and its amorphous nature can be confirmed through X-ray powder diffraction.

X-ray powder diffraction was performed with a Siemens diffractometer using Cu Ka radiation. A graphite monochromator was mounted between the sample and the detector to prevent possible interference from Mn Ka fluorescence induced by incident X-ray. For electrochemical characterization, the cryogel active material in one embodiment of the present invention was stirred with Ketjen black carbon powders and a polytetrafluoroethylene (PTFE) binder in a weight ratio of 60:30:10 (active:carbon:binder) in cyclohexane overnight. After vacuum drying to remove cyclohexane, the mixture was rolled, punched and pressed into 0.25 inch diameter pellets with a thickness around 150 to 200 μm. The pellets were dried at 80° C. under vacuum for about 24 hours.

Upon drying, each of the pellets were placed under argon and mounted onto a stainless steel grid and subjected to electrochemical tests in a three electrode cell, with pure lithium foils serving as both counter and reference electrodes. The electrolyte used was composed of a lithium salt such as LiClO₄ dissolved in an anhydrous organic solvent such as propylene carbonate, with a typical molarity of 1 M. The LiClO₄ salt was dried by heating under vacuum at about 140° C. for about 24 hours before use.

Table 1 shows the reactant ratios, compositions and surface areas of different sodium-doped amorphous manganese oxide cryogel samples, synthesized by reacting sodium permanganate with fumaric acid. This table is shown below.

TABLE 1

| | | Precursor | Mean | | |
|---|---|---|---|---|---|
| | | concen- | Oxidation | | Surface |
| | Sol-Gel | tration | State of | | Area |
| Sample | Reactants | (M) | Mn | Formula | (m²/g) |
| G1 | Sodium | 0.10 | 3.61 | Na_{0.28}MnO_{1.95} | 302 |
| G2 | Perman- | 0.15 | 3.88 | Na_{0.28}MnO_{2.13} | 352 |
| G3 | ganate + | 0.20 | 3.74 | Na_{0.20}MnO_{1.97} | 356 |
| | Fumaric | | | | |
| | Acid | | | | |

With reference to Table 1, reactant ratios, compositions and surface areas of sodium-doped manganese oxide materials with varying sodium to manganese ratios are shown. For the synthesis of these samples, a solution of sodium permanganate was reacted with solid fumaric acid in the molar ratio 3:1. The concentration of the sodium permanganate solution was from about 0.1 to 0.2 M, as indicated in Table 1, and upon reaction with fumaric acid yielding a monolithic hydrogel. The hydrogel was washed repeatedly in de-ionized water to get rid of excess ions and un-reacted species. The hydrogel was then cryogenically frozen in liquid nitrogen and dried under vacuum (i.e., freeze dried) for 24 hours to yield the amorphous manganese oxide-based cryogel.

The freeze-drying process involves freezing the liquid phase in the hydrogel to facilitate its direct sublimation into the vapor phase. The Brauner-Emmet-Teller (BET) surface areas of cryogels obtained from freeze-drying the monolithic hydrogels are typically greater than 300 m²/g (as shown in Table 1). This robust, high surface area nano-architecture has an important role in yielding superior high-rate performance due to the very short, characteristic diffusion lengths in the solid. The high mesoporosity of the material also promotes easy access of the liquid electrolyte to the individual surfaces of the electrode particles, further assisting in attaining higher intercalation capacities at practical discharge rates.

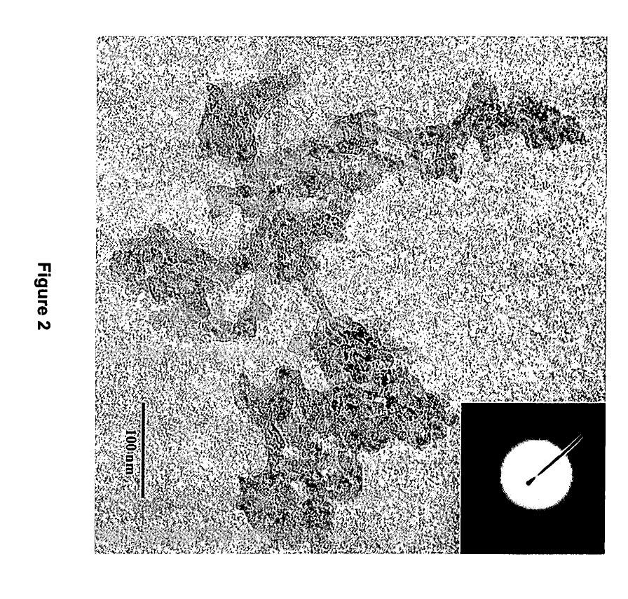

FIG. 2 shows a transmission electron microscope (TEM) image of a typical sodium doped gel sample clearly exhibiting the nanostructured morphology of the cryogel samples. The primary particles appear to be typically in the range of from about 20 to 30 nm in length and seem to form loose aggregates with a high porosity or surface area. The selected area electron diffraction (SAED) pattern, shown in the insert in FIG. 2, also indicates a largely amorphous structure of the material, with no discernible rings or spots in the pattern.

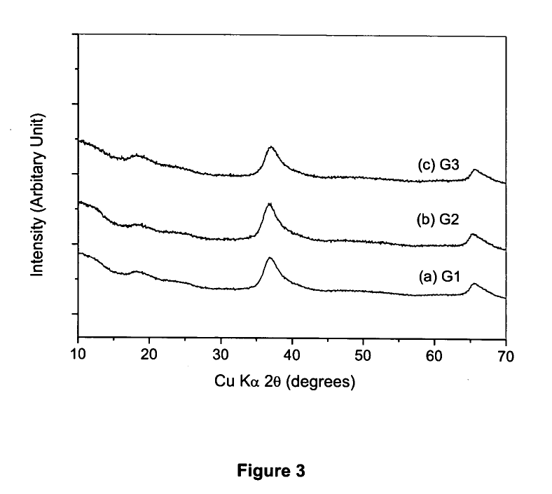

The powder x-ray diffraction (XRD) patterns of these samples are shown in FIG. 3. Each of the patterns exhibited few, very broad peaks that are attributed to weak, edge-shared octahedral arrangement of the manganese. No other peaks corresponding to any long-range or medium-range structural order are observed in the patterns. The concentration of the dopant sodium in these materials is from about 0.2 to 0.3 moles per mole of Mn. The combination of a nanostructured morphology, XRD amorphous structure and a high cationic doping yields a promising electrode material. Such a material potentially offers high capacities at fairly high discharge rates due to the nanostructured morphology, and exhibits a lack of phase transformations or global structural changes due to the amorphous structure thereby yielding stable cycling performance due to the enhanced kinetic stability attained by cationic doping.

The cryogel samples were processed into pellets using procedures described above for testing of electrochemical cycling performance. The pellets were cycled and discharged in a non-aqueous Li solution such as a solution containing LiCIO₄ and a suitable organic solvent such as propylene carbonate. All the pellets were initially discharged from the open circuit voltage to the lower cut-off voltage, followed by cycling between the higher and lower cut-off voltages.

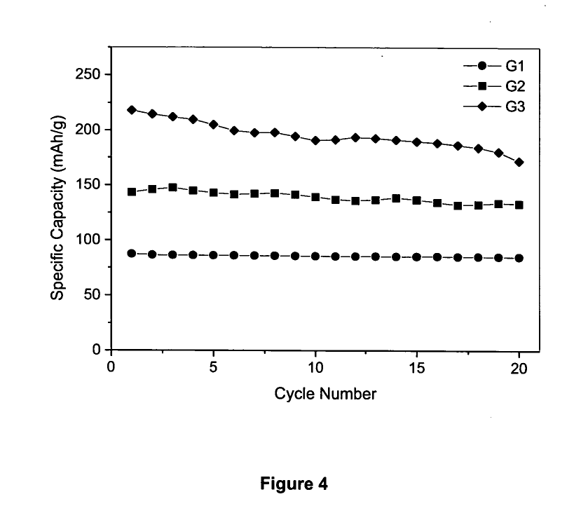

FIG. 4 shows the specific capacity versus cycle number data for these samples with specific capacities in the range of from about 100 to 225 mAh/g, obtained at a current rate of ca. 1 mA/cm² between 1.5 V and 4.0 V. Sample G3 shows a much higher initial capacity of ca. 225 mAh/g. Samples G1 and G2 yield lower intercalation capacities of ca. 80 mAh/g and 145 mAh/g, respectively, but exhibit excellent stability upon repeated cycling. These electrochemical characteristics are extremely promising for a manganese-based intercalation compound. This combination of a relatively high capacity and suitable stability upon cycling, attained for materials synthesized via a low temperature cost efficient aqueous synthesis method, entails significant advantages.

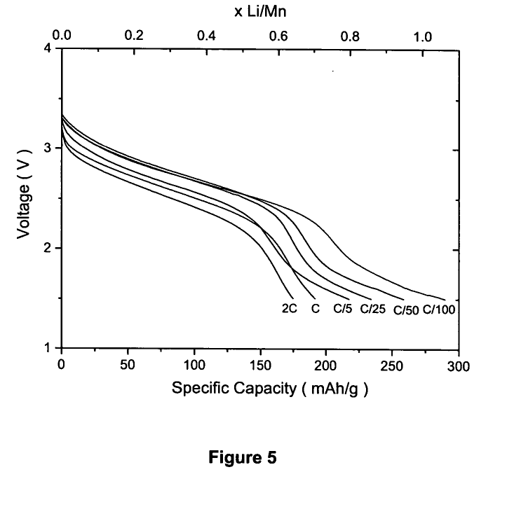

Further, the sample G3, yields capacities of 289 mAh/g, 217 mAh/g and 174 mAh/g at current rates of C/100 (0.06 mA/cm²), C/5 (1 mA/cm²) and 2C (7.25 mA/cm²), respectively (as shown in FIG. 5). These values show a relatively small reduction in capacity with a plenty-fold increase in the current rate and are thus indicative of the superior high rate performance of these high surface area, nanostructured and short-range order cryogels.

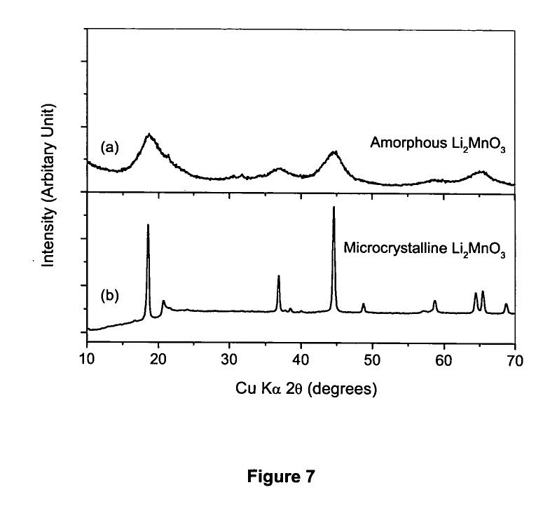

In a preferred embodiment of the present invention, the process comprises reacting fumaric acid with lithium permanganate at a “permanganate to fumaric acid” ratio amount of about 3:1. Optionally, a lithium donor compound such as lithium hydroxide can be added to increase the ratio of lithium to manganese present in the reaction mixture. The ratio of lithium to manganese can range up to 2. A monolithic hydrogel is formed from the reduction reaction. The hydrogel is thereafter cryogenically frozen in liquid nitrogen soon after its formation, and then freeze-dried to obtain a cryogel. The resulting cryogel is then heated at 400° C. for about 24 hours. The samples obtained after this heating step are still very amorphous. FIG. 7 shows the XRD pattern of the sample with a Li/Mn ratio equal to 2. The broad peak widths and weak peaks are seen in all of these samples, indicating that the heating step does not cause any significant crystallization.

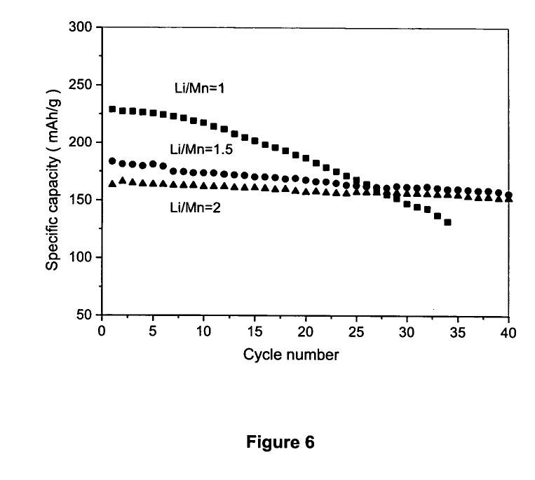

Referring to FIG. 6, the cycling performance of the cryogel samples with lithium to manganese ratios of 1, 1.5 and 2, cycled between 4.0 V and 1.5 V, is shown. Pellets containing a lithium to manganese ratio of 1 exhibited an initial capacity of about 228 mAh/g and a capacity-fading rate of about 1% per cycle over 35 cycles. The cycling performance improves as the lithium to manganese ratio increases. Pellets containing a lithium to manganese ratio of 2 exhibited an initial capacity of about 160 mAh/g and a capacity-fading rate of about 0.1% per cycle over 40 cycles. The data further indicate the presence of a kinetic stabilization effect attained via cationic doping which promotes superior cycling performance.

FIG. 7 shows an X-ray powder diffraction pattern of lithium-containing amorphous nanostructured manganese oxide material with a lithium to manganese ratio of 2, heat treated at about 400° C. for about 24 hours (as shown in FIG. 7(a)), and an X-ray powder diffraction pattern of a fully crystallized sample, obtained by heating at 800° C. (as shown in FIG. 7(b)). Both samples have the same chemical composition, Li₂MnO₃, but possess sharp differences in crystallinity and morphology. The diffraction pattern of the microcrystalline sample (a sample with micron-sized particles and high crystallinity) as shown in FIG. 7(b) exhibit very sharp peaks corresponding to the phase Li₂MnO₃ with a rock-salt structure. The diffraction pattern of the amorphous sample shows similarity to this rock-salt Li₂MnO₃ and is characterized as a short-range-order structure of this phase.

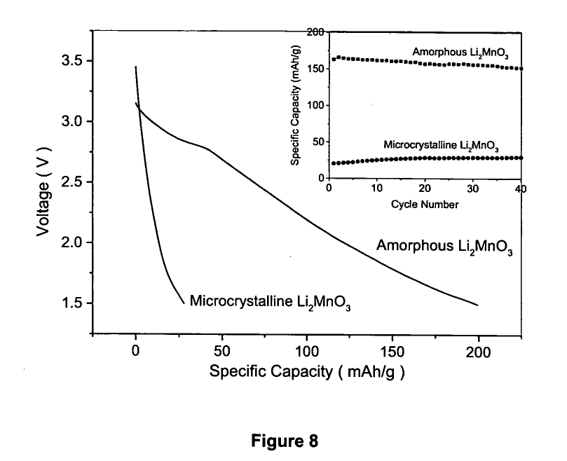

Electrochemical characteristics of these two materials highlight the advantages of nanostructured and largely amorphous materials obtained via low temperature synthesis techniques as described in this invention. FIG. 8 shows the first discharge profile for the two samples obtained at a slow rate of 0.01 mA/cm². The microcrystalline sample yields a capacity of ca. 30 mAh/g whereas the amorphous sample yields a capacity of ca. 200 mAh/g, more than 6 times higher than the former. At a higher rate of 1 mA/cm², the microcrystalline sample shows an initial capacity of 25 mAh/g, whereas the amorphous sample yields a capacity of ca. 160 mAh/g, again more than 6 times higher than the former. Upon repeated cycling at 1 mA/cm², as shown in the insert in FIG. 8, the amorphous sample shows very high reversible capacities in comparison to the microcrystalline sample.

Crystalline Li₂MnO₃ compounds with a rock salt structure have been reported by various researchers and are generally regarded as an electrochemically inactive phase. Lithium cannot be extracted from this material since Mn is already in 4+oxidation state and cannot be reversibly oxidized to higher oxidation states. Lithium cannot be intercalated into this material since all of the octahedral sites in this rock salt structure compound are filled, and intercalation into tetrahedral sites would cause severely detrimental phase transformation. The performance of the amorphous Li₂MnO₃, in this regard, is most striking.

### EXAMPLE

### Synthesis of an Amorphous Nanostructured Sodium Containing Manganese Oxide

A first solution of sodium permanganate solution, 300 mL of 0.25 M NaMnO₄ was prepared. While the first solution was being vigorously stirred, a second solution, 75 mL of 0.300 M fumaric acid disodium salt C₂H₂O₄Na₂ was gradually added. The resulting mixture was allowed to react and form a monolithic hydrogel. The resulting hydrogel was washed multiple times in deionized water and was cryogenically frozen in liquid nitrogen. Lastly, the frozen gel was freeze-dried to yield a sodium containing amorphous nanostructured manganese oxide cryogel.

Although various embodiments of the present invention have been shown and described, they are not meant to be limiting. Those of skill in the art may recognize certain modifications to those embodiments, which modifications are meant to be covered by the spirit and scope of the appended claims.

1. An amorphous nanostructured material useful as an ion intercalation host for rechargeable batteries, comprising a cryogel derived from a freeze dried hydrogel, wherein the hydrogel is formed from a sol-gel reaction.

2. The amorphous nanostructured material of claim 1, is a manganese oxide compound.

3. The amorphous nanostructured material of claim 2, wherein the manganese oxide compound comprises the formula RₓMnO_{2+y/2}, wherein R is a doped cation, and x and y are selected from 0 to 2.

4. The amorphous nanostructured material of claim 3, wherein the doped cation is selected from the group consisting of lithium, sodium, copper, and combinations thereof.

5. The amorphous nanostructured material of claim 1, wherein the cryogel exhibits a specific capacity of at least 80 mAh/g.

6. The amorphous nanostructured material of claim 5, wherein the cryogel exhibits a specific capacity of from about 80 to 250 mAh/g.

7. The amorphous nanostructured material of claim 1, wherein the cryogel exhibits a Brauner-Emmet-Teller (BET) surface area of at least 300 m²/g.

8. The amorphous nanostructured material of claim 1, wherein the sol-gel reaction comprises a reaction between a permanganate salt and a reducing agent.

9. The amorphous nanostructured material of claim 8, wherein the permanganate salt is selected from the group consisting of lithium permanganate and sodium permanganate.

10. The amorphous nanostructured material of claim 8, wherein the reducing agent is selected from the group consisting of fumaric acid and disodium fumarate.

11. A process for making an amorphous nanostructured material useful as an ion intercalation host for rechargeable batteries, comprising the steps of:
preparing an oxide in the form of a hydrogel;
cryogenically freezing the hydrogel; and
drying the frozen gel to yield an amorphous nanostructured oxide cryogel material.

12. The process of claim 11, wherein the oxide is a manganese oxide compound.

13. The process of claim 12, wherein the manganese oxide compound comprises the formula RₓMnO_{2+y/2}, wherein R is a doped cation, and x and y are selected from 0 to 2.

14. The process of claim 13, wherein the doped cation is selected from the group consisting of lithium, sodium, copper, and combinations thereof.

15. The process of claim 11, wherein the cryogel exhibits a specific capacity of at least 80 mAh/g.

16. The process of claim 11, wherein the cryogel exhibits a specific capacity of from about 80 to 250 mAh/g.

17. The process of claim 11, wherein the cryogel exhibits a Brauner-Emmet-Teller (BET) surface area of at least 300 m²/g.

18. The process of claim 11, wherein the preparing step comprises reacting a permanganate salt with a reducing agent.

19. The process of claim 18, wherein the permanganate salt is selected from the group consisting of lithium permanganate and sodium permanganate.

20. The process of claim 18, wherein the reducing agent is selected from the group consisting of fumaric acid and disodium fumarate.

21. The process of claim 11, wherein the preparing step comprises:
preparing a solution containing a permanganate salt combined optionally with a cation donor compound; and
mixing the solution with a reducing agent to yield the hydrogel comprising a manganese oxide.

22. The process of claim 21, further comprising the step of heat treating the dried cryogel.

23. The process of claim 22, wherein the heat treating step further comprises heating the dried cryogel at a temperature and for a time sufficient to induce the manganese to exhibit an oxidation state of 4+.

24. The process of claim 23, wherein the temperature is less than 400° C.

25. The process of claim 23, wherein the temperature is from about 250° C. to 400° C.

26. The process of claim 23, wherein the time is at least 1 hour.

27. The process of claim 23, wherein the time is at least 12 hours.

28. The process of claim 11, wherein the cryogenically freezing step comprises treating the hydrogel with a cryogenic liquid.

29. The process of claim 28, wherein the cryogenic liquid is liquid nitrogen.

30. The process of claim 11, wherein the drying step comprises vacuum drying the cryogel.

31. The process of claim 11, wherein the heat treating step comprises heating the dried cryogel at a temperature of less than 400° C. for at least 1 hour.

32. A process for making an amorphous nanostructured cation-doped manganese oxide material useful as an ion intercalation host for rechargeable batteries, comprising the steps of:
preparing a solution comprising a cation containing permanganate salt combined optionally with a cation donor compound;
mixing the solution with a reducing agent to yield a hydrogel comprising a manganese oxide material;
cryogenically freezing the hydrogel; and
drying the frozen gel to yield an amorphous nanostructured cation-doped manganese oxide cryogel material.

33. The process of claim 32, further comprising the step of heat treating the dried cryogel.

34. The process of claim 33, wherein the heat treating step further comprises heating the dried cryogel at a temperature and for a time sufficient to induce the manganese to exhibit an oxidation state of 4+.

35. The process of claim 34, wherein the temperature is less than 400° C.

36. The process of claim 34, wherein the temperature is from about 250° C. to 400° C.

37. The process of claim 34, wherein the time is at least 1 hour.

38. The process of claim 34, wherein the time is at least 12 hours.

39. The process of claim 32, wherein the cryogenically freezing step comprises treating the hydrogel with a cryogenic liquid.

40. The process of claim 39, wherein the cryogenic liquid is liquid nitrogen.

41. The process of claim 32, wherein the drying step comprises vacuum drying the cryogel.

42. The process of claim 32, wherein the heat treating step comprises heating the dried cryogel at a temperature of less than 400° C. for at least 1 hour.

43. The process of claim 32, wherein the cation is selected from the group consisting of lithium, sodium, and copper.

44. The process of claim 32, wherein the reducing agent is selected from the group consisting of fumaric acid, and disodium fumarate.

45. The process of claim 32, wherein the manganese oxide material comprises the formula RxMnO_{2+y/2}, wherein R is a doped cation, and x and y range from 0 to 2.

46. The process of claim 45, wherein the doped cation is selected from the group consisting of lithium, sodium, copper, and combinations thereof.

47. The process of claim 32, wherein the cryogel exhibits a specific capacity of at least 80 mAh/g.

48. The process of claim 32, wherein the cryogel exhibits a specific capacity of from about 80 to 250 mAh/g.

49. The process of claim 32, wherein the cryogel exhibits a Brauner-Emmet-Teller (BET) surface area of at least 300 m²/g.

50. The process of claim 32, wherein the permanganate salt is selected from the group consisting of lithium permanganate and sodium permanganate.

51. The process of claim 32, wherein the reducing agent is selected from the group consisting of fumaric acid and disodium fumarate.

52. A process for making an amorphous nanostructured lithium-containing manganese oxide material useful as an ion intercalation host for rechargeable batteries, comprising the steps of:
preparing a solution containing lithium permanganate combined optionally with lithium hydroxide;
mixing the solution with a reducing agent to yield a hydrogel;
freezing the hydrogel in a liquefied gas;
drying the frozen gel to yield an amorphous nanostructured lithium-containing manganese oxide cryogel; and
optionally, heat treating the dried cryogel.

53. An amorphous nanostructured oxide material useful as an ion intercalation host for rechargeable batteries, prepared by the process of claim 11.
